(19) United States
(12) Patent Application Publication
(10) Pub. No.: US 2007/0150355 A1
(43) Pub. Date: Jun. 28, 2007

(54) Web-based incentive system and method

(76) Inventor: Anthony F. Meggs, Viera, FL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/708,587

(22) Filed: Feb. 21, 2007

Related U.S. Application Data
(63) Continuation-in-part of application No. 11/267,210, filed on Nov. 7, 2005.

(51) Int. Cl. G06Q 30/00

(52) U.S. Cl. 705/14

(57) ABSTRACT

A method for providing an incentive to an Internet user to interact with a website. The present invention includes a network capable of capturing a portion of money related to Internet commerce, and allocate said money in a manner that provides incentive to an Internet user to interact with a website. The network architecture includes a smart client configured to request services from network servers.

### CROSS-REFERENCE TO RELATED APPLICATIONS

This application claims priority to, and is a continuation-in-part application of, U.S. patent application entitled, Web-Based Incentive System and Method, filed Nov. 7, 2005, having a Ser. No. 11/267,210, (now pending) the disclosure of which is hereby incorporated by reference in its entirety.

### FIELD OF THE INVENTION

The present invention relates generally to a network. More particularly, the present invention relates to a system and method for providing an incentive to network users.

### BACKGROUND OF THE INVENTION

Paid search marketing programs are in wide use across the Internet. In these known marketing programs, Internet vendors selling products, services, or information bid in an open auction environment for positions on a search result list generated by an Internet search engine. For example, Internet vendors agree to pay a certain amount to the search engine provider in exchange for a favorable position on the search result list. Total payments are often directly related to the position on the search result list and the number of “click-thrus” generated by the search result list.

The higher an Internet vendor's position on a search result list, the higher likelihood of a “click-thru.” Thus, these known marketing programs provide incentive for the Internet vendor to select and highly bid on those search keywords or phrases that are most relevant to their website offerings.

In addition to a favorable position on the search result list, the likelihood of a “click thru” also depends on the Internet user's personal incentive to click on the Internet vendor's hyperlink. The current, most prevalent incentive is limited to the user's desire to view the vendor products, services, or information that is relevant to their keyword search. Thus, the vendor's position on the search result list combined with the user's desire to view the vendor's products, services, or information combine to determine, in large part, whether the user will actually “click-thru” to the vendor's website.

Known search marketing programs do not provide incentive to “click-thru” beyond the user's desire to view the vendor's products, services, or information and strategic vendor positioning; additionally, current systems are limited only to click-thrus within the context of either search-engine result lists or results served-up at affiliate websites. Current systems provide incentive to Internet vendor's to bid on favorable positions on search result lists. For example, increased traffic on an Internet vendor's website results in increased sales revenue. Moreover, current systems also provide incentive to the search engine provider to create a more efficient system. A search engine provider's improved performance and content will draw more consumers consequently generating more search revenue. For example, Google AdWords has been visited by millions of Internet users, and has generated billions of dollars in paid search revenue for Google. Search engine provider revenue is directly tied to search engine performance and requires an extraordinarily large IT infrastructure to deliver on performance and maintain competitiveness to capture search-marketing revenue.

There is a need to provide additional incentive to Internet users and, thus, even further increase the effectiveness and efficiency of paid searching marketing programs.

### SUMMARY OF THE INVENTION

An exemplary way to provide additional incentive to an Internet user is to direct a portion of the Internet vendor's bid amount, as a benefit, to the Internet user in exchange for the Internet user's prioritization and interaction with participating Internet vendors Another exemplary way to provide additional incentive to an Internet user is to direct a portion of the Internet vendor's bid, as a benefit, to a third-party beneficiary in exchange for the Internet user's prioritization and interaction with Internet vendors Additional incentive is provided by enabling the Internet user to designate the third-party beneficiary. Accordingly, it is desirable to provide a method and system capable of concurrently providing incentive to the Internet users and fulfilling the Internet venders' interest in effectively marketing to Internet users.

The present invention fulfills these interests by providing a system and method for enabling an Internet user to identify and prioritize Internet vendors willing to direct a benefit to himself or to a third-party beneficiary by interacting with an Internet vendor's website, content, advertisement or message. This is accomplished with virtually no change in the Internet user's search behaviors and with a relatively minor IT infrastructure when compared to leading search engine providers. For example, the system and method provides a paid search engine marketing system, wherein a portion of the Internet vendor's bid or pledge is allocated as a financial incentive, to an account owned by the Internet user or to a charity designated by the Internet user—instead of only paying the search engine administrator—upon an a “click-thru” or some other Internet user interaction. The system and method of the present invention will provide incentive to Internet users to prioritize and interact with participating Internet users and thereby increase effectiveness and efficiency of the paid searching marketing program.

The foregoing needs are met, to a great extent, by the present invention, wherein in one aspect a system is provided that in some embodiments enables an Internet user to capture and direct a financial incentive to a beneficiary account by interacting with an Internet vendor's website, content, message and/or advertisement.

In accordance with one embodiment of the present invention is a system for enabling an Internet user to appropriate a benefit by interacting with a website, content, message or advertisement that is promoted by an Internet vendor, comprising an Internet vendor account for each of a plurality of Internet vendors registered in the system, wherein the Internet vendor account includes a pledge or bid amount for a specific Internet user activity, an Internet user account for each of a plurality of Internet users registered in the system; and a smart client configured to monitor a user activity of the Internet user, present data from the Internet vendor account, enable the user to sort and filter Internet vendor data across multiple dimensions, and provide the user activity to a web server, wherein the web server is configured to allocate the benefit based on the user activity.

In accordance with another embodiment of the present invention is a method for enabling an Internet user to appropriate a benefit by interacting with a website, content, message or advertisement that is promoted by an Internet vendor, comprising: maintaining a database having stored thereon: an Internet vendor account for each of a plurality of Internet vendors registered in the system, wherein the Internet vendor account includes a pledge or bid amount; an Internet user account for each of a plurality of Internet users registered in the system; monitoring a user activity of the Internet user; cross-referencing the Internet user's activity or data input with data located in the Internet vendor account to identify a common term or data input; presenting data that is located in the Internet vendor account to the Internet user when the common term or data input is identified; monitoring an interaction between the Internet user and the website, content, message or advertisement that is promoted by the Internet vendor; and allocating the benefit.

In accordance with yet another embodiment of the present invention is a method for providing an incentive to an Internet user to interact with a website, content, message or advertisement promoted by the Internet vendor, comprising: monitoring a user activity of an Internet user; searching a database for an Internet vendor based on the user activity; presenting an advertisement, content, message or image icon that hyperlinks to a website that is maintained by the Internet vendor; monitoring an interaction between the Internet user and the website; and allocating a benefit.

In accordance with one embodiment of the present invention is a system for enabling a wireless communications device user to appropriate a benefit by interacting with a broadcast source that is promoted by a vendor, comprising an vendor account for each of a plurality of vendors registered in the broadcast system, wherein the vendor account includes a pledge, or bid amount; a wireless user account for each of a plurality of wireless users registered in the system; and a smart agent configured to present data of the vendor account, monitor the user activity of the wireless user, and provide the user activity to a broadcast server via the wireless network, wherein the broadcast server is configured to allocate the benefit based on the user activity.

In accordance with one embodiment of the present invention is a system for enabling an IP based communications device user to appropriate a benefit by interacting with an IP based broadcast source that is promoted by a vendor, comprising a vendor account for each of a plurality of vendors registered in the IP based broadcast system, wherein the vendor account includes a pledge amount; an IP based device user account for each of a plurality of IP based device users registered in the system; and a smart agent configured to present data of the vendor account, monitor the user activity of the IP based device user, and provide the user activity to a broadcast server via the IP based network, wherein the IP based broadcast server is configured to allocate the benefit based on the user activity.

In another embodiment of the present invention, a permissive search method is provided. The method includes: storing user profile data that includes vender preferences and a user benefit account; storing vender profile data that includes vender preferences and a benefit amount; monitoring a search query initialed by the user; and displaying to the user a first set of search results including vender information of venders having common vender preferences with the user profile data and information sought in the search.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating the relationship between a large network and an embodiment of the network participants.

FIG. 2 is a block diagram illustrating the relationship between a large network and an embodiment of the system and method for enabling an Internet user to indirectly donate to a beneficiary by interacting with an Internet vendor's website.

FIG. 3 is a flowchart illustrating an exemplary process invoked by the system and method for enabling an Internet user to indirectly donate to a beneficiary by interacting with an Internet vendor's website.

FIG. 4 is a block diagram illustrating a server and exemplary programs stored therein and executed therefrom according to one embodiment of the present invention.

FIG. 5 is a chart of menus, display screens, and input screens used in one embodiment of the present invention.

FIG. 6 is a flowchart illustrating an exemplary process invoked by the system and method for enabling an Internet user to indirectly donate to a beneficiary by interacting with an Internet vendor's website

FIG. 7 is a chart of menus, display screens, and input screens used in one embodiment of the present invention.

FIG. 8 is a chart of menus, display screens, and input screens used in one embodiment of the present invention.

FIG. 9 is a chart of menus, display screens, and input screens used in one embodiment of the present invention.

FIG. 10 is a chart of menus, display screens, and input screens used in one embodiment of the present invention.

FIG. 11 illustrates an example of a search result list generated by one embodiment of the present invention.

FIG. 12 illustrates an example of a Permissive Search Agent window according to one embodiment of the present invention.

### DETAILED DESCRIPTION

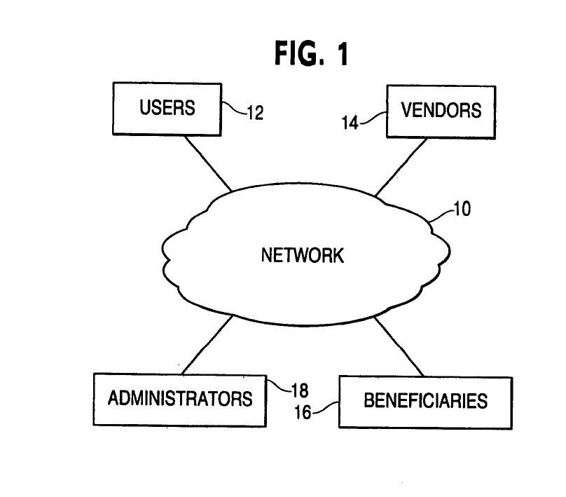

FIG. 1 represents a network 10 capable of enabling an Internet user 12 to capture and redirect a portion of an Internet vendor's search marketing and advertising dollars. The network 10 enables the Internet user 12 to redirect said captured dollars to a beneficiary 16. The beneficiary 16 can be an account owned by the Internet user 12 or an account owned by a third-party. As shown in FIG. 1, the network 10 includes Internet users 12, Internet vendors 14, beneficiaries 16, and administrators 18.

In an embodiment, beneficiaries 16 are accounts owned by the Internet user 12. For example, the beneficiary 16 can be the user's 12 IRA account, membership rewards account, the user's college saving account, the user's health saving account, etc. In another embodiment, beneficiaries 16 are accounts owned by third-party organizations, e.g., charitable organizations that generate some portion of their revenue in the form of donations. In another embodiment, beneficiaries can be an account of “unvested” reward points that can be converted into “vested” reward point or cash in correlation with the user's actual purchasing activities. Internet users 12 are those engaged in Internet activity and interested in directing a financial benefit to their designated beneficiaries 16. Internet vendors 14 are organizations interested in effectively marketing to Internet users 12 and willing to have a portion of their search marketing dollars allocated to the user's chosen beneficiaries 16 in exchange for said effective marketing. Administrators 18 manage the network 10.

The network 10 is capable of concurrently fulfilling at least four interests: 1) the Internet user's 12 interest in finding specific products or services 2) the Internet users' 12 interest in supporting at least one beneficiary 16; 3) the Internet venders' 14 interest in effectively marketing to Internet users 12; and 4) the beneficiaries' 16 interest in collecting support. It should be appreciated that the beneficiaries' 16 interest and the Internet users' 12 interest are substantially similar when the Internet user 12 has an interest in the beneficiary 16. For example, the Internet user has an interest in the beneficiary 16 when the beneficiary 16 is an account owned by the Internet user 12.

First, the Internet user's 12 interest in finding specific products or services is fulfilled because, in an embodiment, the present invention enables the Internet user 12 to conduct a keyword search in a search engine (e.g., GOOGLE, MSN, YAHOO, etc) or on a website having its own search engine. The systems and methods of the present invention automatically detect and monitor the search activity. Based on the detected search activity, the present invention conducts a parallel search of Internet vendors 14 that provide the sought products or services, as well as have allowed a portion of their search marketing dollars be allocated as a benefit to the Internet user The present invention presents advertisements, content, and image icons with embedded uniform resource locators (URLs) of the applicable Internet vendors 14.

It should be appreciated that the aforementioned example is illustrative and there exists multiple embodiments of the present invention capable of fulfilling the Internet user's interest in finding specific products or services. For example, an Internet vendor can access the present invention and designate the URLs of competitors that offer related products and services or designate URLs currently owned by the Internet vendor. If the Internet user 12 accesses a designated competitor URL or a designated Internet vendor URL, the present invention can present the Internet vendor's 14 advertisement, content and/or data to the Internet user 12. It should also be appreciated that the present invention can scan the context of the web page being viewed by the Internet user 12 for designated keywords, search terms and content. When an Internet user 12 lands on a web page containing designated keywords and search terms, the present invention can present the Internet vendor's 14 URL to the Internet user 12. It should also be appreciated that the Internet user 12 can conduct keyword search exclusively within the present invention. The aforementioned examples are discussed in more detail below.

Second, the Internet user's 12 interest in directing a benefit to designated beneficiaries 16 is fulfilled because the Internet vendor 14 donates or allocates a portion of internet marketing dollars to beneficiaries 16 based on the Internet user's 12 interaction with the Internet vendor's 14 website, advertisement, content and/or messages. Internet vendors 14 set pledges or bids, that are contingent on Internet users' 12 interaction with the Internet vendors' 14 respective websites, content, messages or advertisements. A portion of these pledges and bids are converted into a benefit amount and allocated to the Internet users designated beneficiaries 16. For example, an Internet vendor 14 can pledge or bid an amount in exchange for Internet users' 12 providing their profile information to the Internet vendor 14 via the smart client. If the Internet user 12 chooses to provide profile information to the Internet vendor 14, then a portion of the pledge amount is converted into a benefit and allocated to the Internet user's 12 designated beneficiaries 16. Thus, an Internet user 12 can direct a benefit to a designated beneficiary 16 by providing profile information to an Internet vendor 14.

Third, the Internet venders' 14 interest in effectively marketing to the Internet users 12 is accomplished because network 10 provides significant incentive to the Internet user 12 to interact with the Internet vendors' 14 websites, content, messages or advertisements. The incentive exists because the level of Internet user 12 interaction with the Internet vendor's 14 is directly proportional to the benefit amount that is converted from the Internet vendor 14 pledges or bids for user interactions. This incentive will encourage many Internet users 12 to provide personal information to Internet vendor's 14, which can be used for effective marketing.

Fourth, the beneficiaries' 16 interests are satisfied because they receive revenue from Internet users 12 by-way-of the Internet vendors 14. It should be appreciated that beneficiaries 16 can be the Internet user's frequent flyer miles account, membership rewards accounts, 401k account, etc. It should also be appreciated that the benefit amount may be in a form of cash, vested points and unvested points

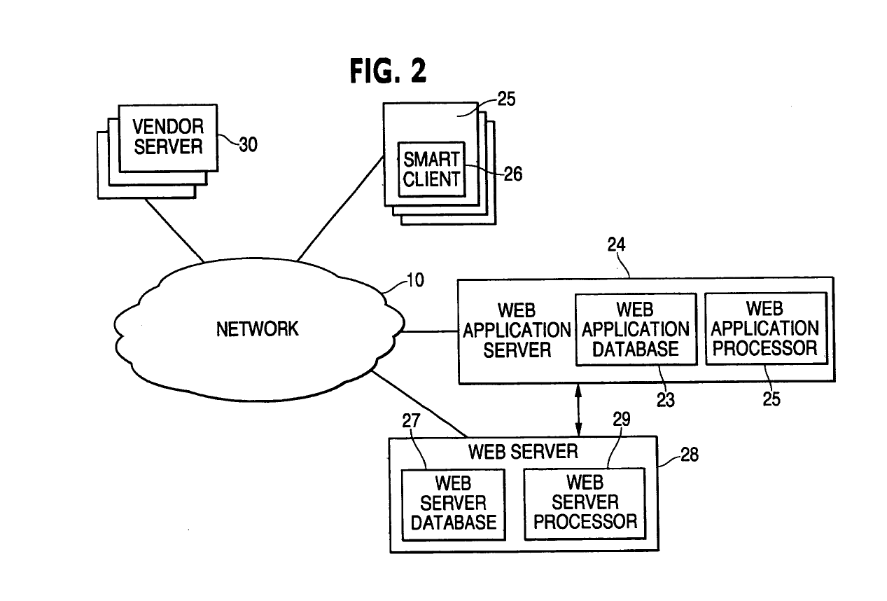

Referring now to FIG. 2, an example of the preferred architecture used in the network 10. In an embodiment, the network 10 is a client/server network such as the Internet. Thus, the terms network 10 and Internet are use interchangeably hereinafter. A client is as a requester of services and a server is a provider of services. For example, a client is a computer program running on a computer that accesses resources shared by a server, and the server is another computer running a corresponding server program.

As shown in FIG. 2, the network 10 includes a smart client 26 configured to request services from network 10 servers such as a web application server 24, a web server 28, and a vendor server 30. The smart client 26, for example, can run on a computer that accesses the network 10 resources provided by another computer running a corresponding server program. Although the system and method of the present invention is useful for the Internet, it should be understood that the client 26 and the servers 24, 28, and 30 may be connected together through one of a number of different typed of networks. Such networks may include WIFI, local area networks (LANs), other wide area networks (WANs), and regional networks accessed over telephone and cellular lines, such as commercial information services. The client 26 and server 24, 28, and 30 processes may even include different programs executing simultaneously on a single computer.

The computers 25 (or any other device that can connect with a network) on which the smart client 26 runs can be conventional personal computers (PCs), workstations, or computer systems of any other size. Each computer 25 typically includes one or more processors, memories, input/output devices, and a network interface. The servers 24, 28, and 30 can be similarly configured. However, the servers 24, 28, and 30 may each include many computers connected by a separate private network. In fact, the network 10 may include hundreds of thousands of individual networks of computers.

The smart client program 26 can execute within web browser programs, such as the NAVIGATOR, EXPLORER, or MOSAIC browser programs. The browser programs allow the Internet user 12 to enter addresses of specific web pages to be retrieved or keyword searches that refer the Internet user to a website address that provides relevant and specific advertisements and/or content. These addresses are referred to as Uniform Resource Locators (“URLs”). In addition, once a page has been retrieved, the browser programs can provide access to other pages or records when the Internet user 12 “clicks” on hyperlinks to other web pages. Such hyperlinks are located within the web pages and provide an automated way for the user to enter the URL of another page and to retrieve that page. The pages can be data records including as content plain textual information, or more complex digitally encoded multimedia content, such as software programs, graphics, audio signals, videos, and so forth.

In an embodiment of the present invention, as shown in FIG. 2, the smart client 26 communicates, through the network 10, with various network information providers, including web application server 24, web server 28, and vendor servers 30 using the functionality provided by a HyperText Transfer Protocol (HTTP), although other communications protocols, such as FTP, SNMP, TELNET, and a number of other protocols known in the art, may be used. Preferably, the web application server 24, the web server 28, and the vendor servers 30 are located on the World Wide Web.

The web application server 24 includes a computer storage medium 23 and processing system 25. The storage medium 23 contains Internet user account information, Internet vendor account information, beneficiary account information, and administrator account information. It should be appreciated that the system and method of the present invention may be implemented in software that is stored as executable instructions on a computer storage medium, such as memories or mass storage devices, on the web application server 24. Conventional Internet browser programs, running on the client computers 25, may be used by the Internet user 12, the Internet vendor 14, the beneficiary 16, and the administrator 18 to access their respective accounts stored on the web application server 24. Preferably, access to the web application server 24 is accomplished through a firewall, which protects the account information stored thereon from external tampering.

In an embodiment, the web server 28 is directly connected to the web application server 24 and the network 10. The web server 28 includes a computer storage medium 27 and a processing system 29. The storage medium 27 includes Internet vendor data for generating search results in response to the Internet user 12 keyword queries. It should also be appreciated that the present invention utilizes a natural language interpretation method to generate results in response to Internet user's 12 activity. A keyword search program operating on the web server 28 enables Internet users 12, upon submitting queries to the web server 28 by typing a keyword search into the smart client 26, to identify Internet vendor data of interest among the many webpages, advertisements and content promoted by Internet vendors 14. It should be appreciated that the keyword search program also enables Internet users 12 to type keyword searches to identify webpages, content and advertisements of interest among the many available on the World Wide Web that are not promoted by Internet vendors 14. Further, it should be appreciated that the keyword search program enables Internet users 12 to identify only those webpages, content, and advertisements of interest that are promoted by Internet vendors 14 that allocate a portion of their internet marketing dollars as a benefits to the beneficiaries 16 that are designated by the Internet user.

It should be appreciated that other embodiments exist for conducting searches. For example, websites often provide search boxes or search functions that are separate from the targeted search engines included in the present invention, e.g., GOOGLE, YAHOO, etc. Based on a generated search inquiry, a matching program operating on the web server 28 can search the storage medium 23 to locate relevant Internet vendor's 14 URLs. The relevant URLs can then be presented to the Internet user 12.

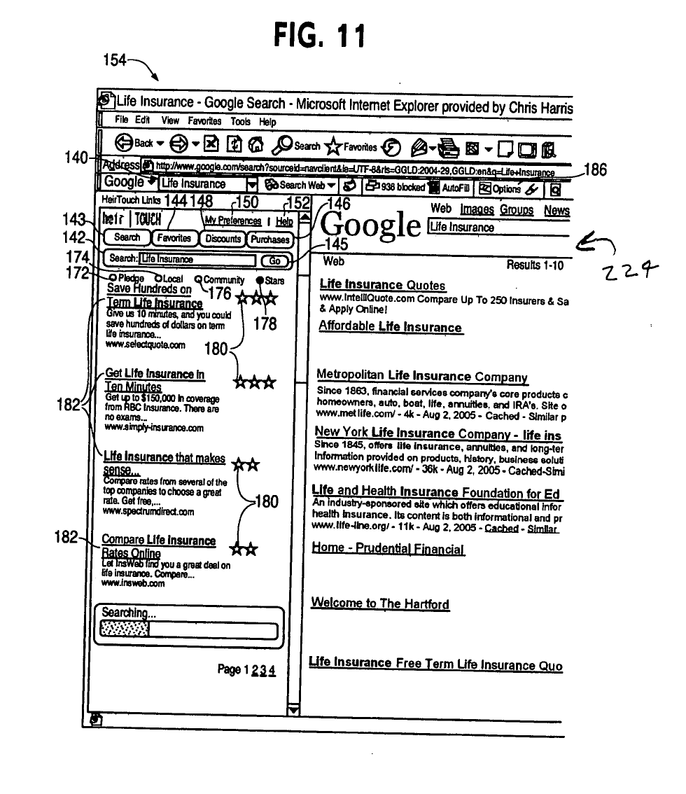

In an embodiment of the present invention, a keyword search program is located on web server 28 and the keyword search program is configured to generate a search result list that includes, among other things, relevant entries obtained from and formatted by the Internet vendors 14 as stored in the web application server 24. The web server 28 generates a list of hypertext links to documents that contain information relevant to search terms entered by the Internet user 12 and transmits this list to the Internet user 12 via smart client 26 interface. An example of such transmission via the smart client 26 interface is shown in FIG. 11, which will be discussed below in further detail.

The web application server 24 and the web server 28 address the different information needs of the Internet users 12, Internet vendors 14, and beneficiaries 16. However, it should be appreciated that the web application server 24 and the web server 28 can be combined into one server capable of serving the Internet users 12, Internet vendors 14, and beneficiaries 16.

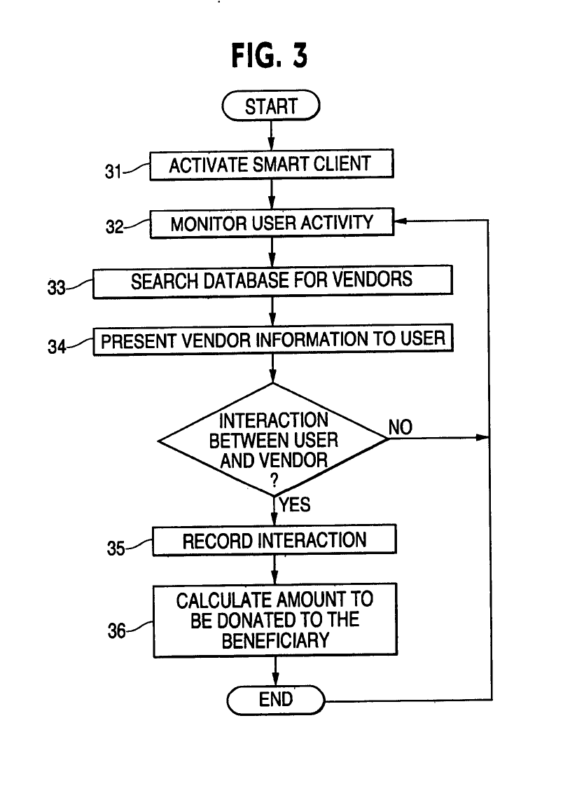

FIG. 3 is an example process executed by the system. First, as shown in step 31, the smart client 26 is activated. Upon activation, the smart client 26, in step 32, monitors the Internet activity of the Internet user 12. The smart client 26 transmits Internet user activity data to the web server 28. As shown in step 33, the system invokes a process on the web server processor 29. The invoked process searches the web server database 27 for target Internet vendor data such as webpages, content, messages or advertisements. Target Internet vendor data, for example, are those webpages, content, messages or advertisements that are relative to the Internet user's 12 activity and, in addition to relevancy, are promoted by Internet vendors 14.

Once target Internet vendor data is identified, the system presents the corresponding hyperlinked data to the Internet user 12, as indicated by step 34. If the Internet user 12 does not click on the presented hyperlinked data, the system returns to step 32. If the Internet user 12 clicks on the presented hyperlink data; this is known as a “click thru,” the system proceeds to step 35. In step 35, the system records the click-thru in the web application database 23. Next the system access the vendor's pledge amount and, based on the pledge amount, calculates the amount to be donated to the beneficiary 16, as shown in step 36.

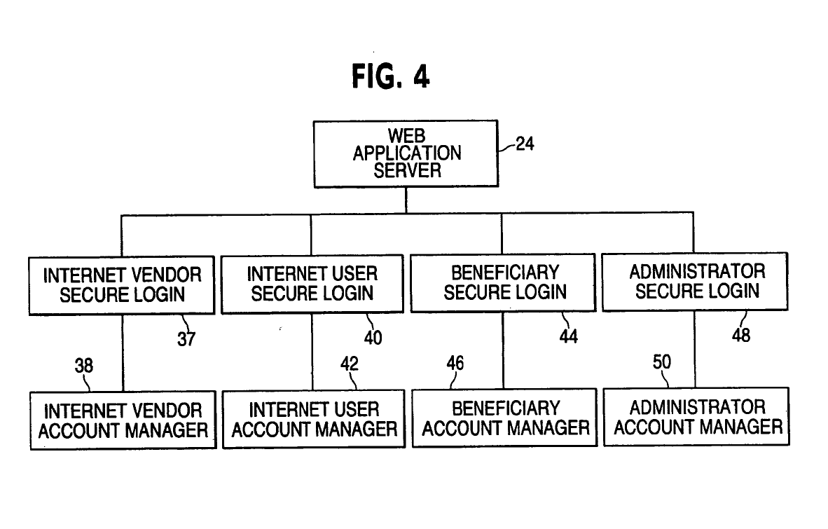

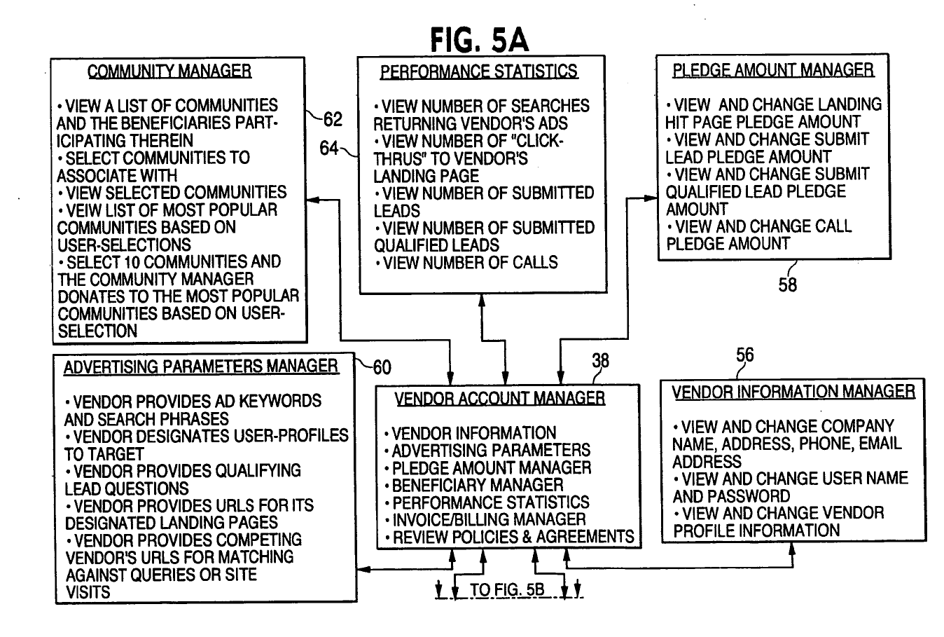

Shown in FIG. 4 are exemplary programs stored and executed on the web application server 24. The programs include a Internet vendor secure login 37, a Internet vendor account manager 38, an Internet user secure login 40, an Internet user account manager 42, a beneficiary secure login 44, a beneficiary account manager 46, an administrator secure login 48, and an administrator account manager 50.

For example, in operation the Internet vendor 14 can access the web application server 24 via the client computer 26, and the web application 24 presents the Internet vendor secure login 37. Upon access to the Internet vendor secure login 37, the Internet vendor 14 inputs a valid username and password.

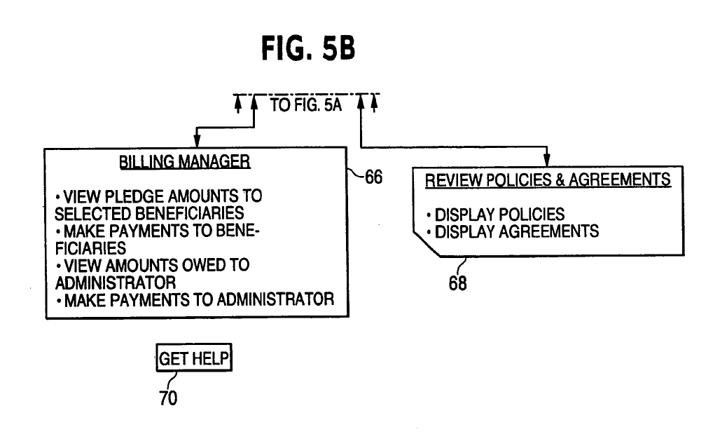

Referring now to FIG. 5, an exemplary embodiment of the vendor account manager 38 is shown. Upon a successful login, the web application server 24 provides the vendor account manager 38. The vendor account manager 38 has a number of options and further services for the Internet vendor 14. These items, which will be discussed in more detail below, cause routines to be invoked to either implement the Internet vendor's 14 request or request further information prior to implementing the Internet vendor's 14 request. In one embodiment of the present invention, the Internet vendor 14 may access several options through manager 38, such as the vendor information manager 56, the pledge amount manager 58, the advertising parameters manager 60, the community manager 62, the performance statistics manager 64, the invoice/billing manager 66, and policies and agreements viewer 68. A get help link 70 may also be available at the vendor account interface 34.

The vendor information manager 56 that enables an Internet vendor 14 to, among other things, view and change its contact information. For example, the Internet vendor 14 can view and update its address, phone number, email address, and billing information. The information manager 56 also allows the Internet vendor 14 to view and change its username and password. Further, the vendor 14 can view and change its profile information. For example, profile information includes whether the vendor 14 is a religious owned business, non-for-profit business, for-profit business, or a secular commercial business.

The pledge or bid amount manager 58 allows the Internet vendor 14 to view and change its pledge or bid amounts. Pledge or bid amounts are set and paid by vendors 14 in exchange for Internet users 12 interacting with the vendors' 14 website, content, message or advertisement. The Internet vendor 14 can set pledge or bid amounts based on the type of Internet user's 12 interaction. For example, the Internet vendor 14 can pledge a specific amount for a landing hit page. A landing hit page occurs when an Internet user 12 clicks on the Internet vendor's 14 hyperlink advertisement, content, message or image icon and is thereby routed to the Internet vendor's specified landing webpage. Thus, when an Internet user clicks on the vendor's 14 hyperlink, the vendor 14 pays the system administrator the designated pledge amount and the pledge amount is converted into a benefit amount and allocated to the beneficiary 16.

In one embodiment, upon registering in the network 10, the Internet user 12 agrees to provide his/her profile information to Internet vendors 14 upon accessing landing webpages. Internet user 12 profile information, for example, includes the user's 12 location, age, sex, and income. Thus, each time an Internet user 12 accesses a landing webpage, the corresponding vendor 14 receives that particular user's 12 profile information, and in return, the vendor 14 allocates a benefit to a beneficiary 16 as designated by the Internet user 12. Profile information is considered by many vendors 14 to be valuable information.

An advantage of the present invention is Internet vendors 14 are less susceptible to click-fraud. Click-fraud is a problem in the prior art because internet users can repeatedly click hyperlinks and thereby fraudulently deprive vendors of money. An embodiment of the present invention prevents click-fraud because each Internet user 12 agrees to register, and thereby provide his/her personal information, before using the network 10. Thus, an Internet user 12 cannot repeatedly interact with a Internet vendor's 14 website, and thereby fraudulent deprive the vendor 14 of money, without revealing his/her identity to the administrator 18. Because the administrator 18 can monitor all Internet user's 12 activities, trends and patterns, the administrator 18 can either stop the user 12 continuing click fraud or suppress the number of interaction opportunities and/or reimburse the vendor 14 of fraudulently induced benefits. Further, the administrator 18 can implement an algorithm to disable or suppress a user's 12 account if the user's 12 ratios of click-thrus to leads to qualified leads indicate click-fraud. Leads and qualified leads are discussed in further detail below.

The Internet vendor 14 can pledge a different amount in exchange for the Internet user 12 submitting a lead to the Internet vendor 14 by-way-of the smart client. A submit lead occurs when the Internet user 12 agrees to provide the Internet vendor 14 with more detailed information, such as a detailed profile that includes contact information. Detailed profile information, for example, includes but not limited to the Internet user's 12 name, address, telephone number, and email address. In an alternative embodiment, the Internet vendor 14 can allocate another benefit amount to the designated beneficiary 16 in exchange for the Internet user 12 submitting a qualified lead to the Internet vendor 14. A qualified lead occurs when the Internet user 12 agrees to answer qualifying questions as determined by the Internet vendor 14. Further, the Internet vendor 14 can allocate another benefit in exchange for the Internet user 12 submitting a telephone call. This occurs when the Internet user 12, as a result of interacting with the Internet vendor's website, content, advertisement or message, calls the Internet vendor 14.

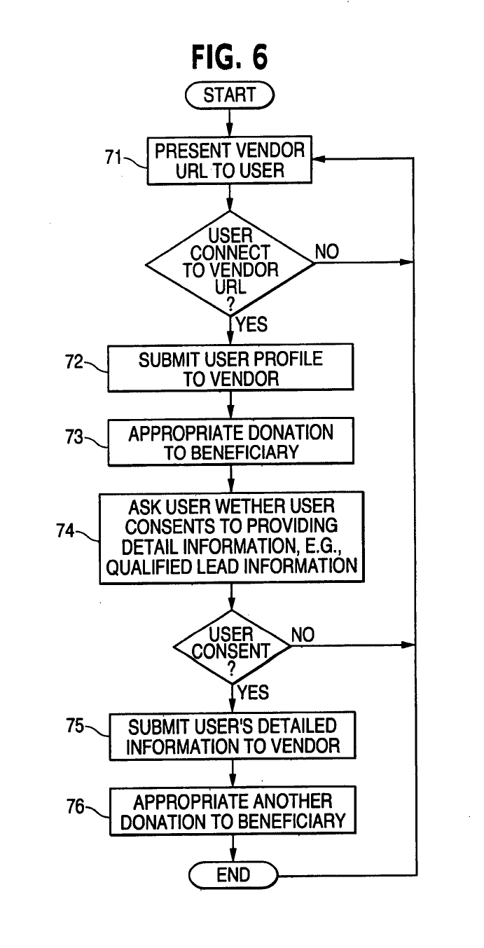

The aforementioned increasing pledge amount system can be understood by reference to FIG. 6. When the smart client 26 presents vendor 14 information to the user 12, as shown in step 71, the smart client 26 monitors the Internet user 12 activity. If the Internet user 12 does not interact with the vendor 14 information, the smart client 26 continues to present other vendor 14 information to the Internet user 12 and continues to monitor the interaction of the Internet user 12 with the vendor 14 information.

If the Internet user 12 does interact with the vendor 14 information, a function is invoked which receives data identifying the Internet user 12 and retrieves the user's 12 profile information from web application server 28. The executing process then submits the user's 12 profile information to the vendor 14 in step 72. The executing process invokes a function that retrieves the vendor's 14 pledge or bid amount information from the web server 28. The executing process then accesses the vendor's account manager 42 and records the interaction amount and allocated benefit amount. Next, the executing process appropriates the benefit to the beneficiary 16, as shown in step 73. It should be appreciated that the benefit can be appropriated in a number of ways. For example, the administrator can submit the benefit to the beneficiary 16 and later bill the vendor 14. Also for example, the vendor 14 can submit the benefit directly to the beneficiary. It should also be appreciated that the aforementioned payments can be electronic transfers.

As shown in step 74, the smart client 26 next asks the user 12 whether the user 12 agrees to provide additional information to the vendor 14 in exchange for the vendor 14 allocating another benefit amount to the beneficiary 16. If the user 12 does not agree, then the executing process returns to step 71. If the user 12 agrees to provide additional information, then the process invokes a function that accesses the vendor's 14 account manager 38 to determine what additional user 12 information the vendor 14 wants and then prompts the user 12 to provide such information. It should be appreciated that the user 12 can submit the additional information via the smart client 26 interface or the executing process can automatically obtain the additional information from the web server 28. Next, in step 75, the user's 12 addition information is submitted to the Internet vendor 14.

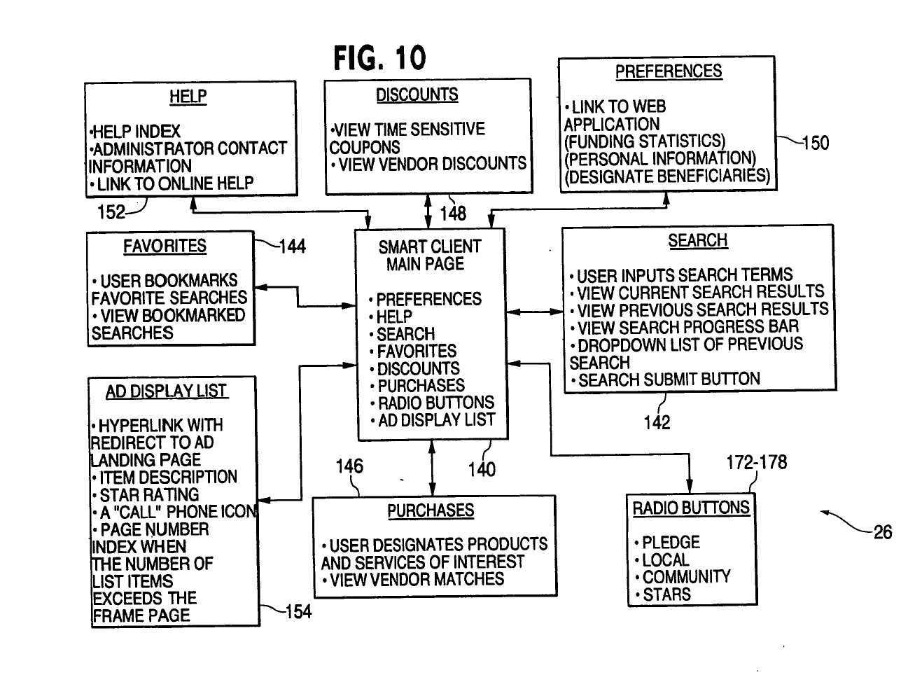

Next, the executing process invokes a function that retrieves the vendor's 14 pledge or bid amount information. The executing process then accesses the vendor's account manager 42 and records the interaction amount and allocated benefit amount. Next, the executing process appropriates the benefit to the beneficiary 16, as shown in step 76 and then returns to step 71. It should be appreciated that the executing process of FIG. 10 can be repeated a number of times. There is not a limit to the amount of information the user 12 can provide to the vendor 14 and there is not a limit on the number of times the vendor 14 can allocate a benefit to the beneficiary 16 in exchange for said information.

Referring again to FIG. 5, the advertising parameters manager 60 allows the vendor 14 to view and change parameters and affect the user's 12 attraction to the vendor's 14 website, content, messages and advertisements. For example, the vendor 14 can view and change ad keywords and search phrases. The vendor 14 selects ad keywords and search phrases that are relevant to the content of the vendor's 14 website. Ideally, the vendor 14 may select ad keywords and search phrases that are targeted keywords and phrases likely to be entered by users 12 while searching the Internet.

Internet vendors 14, via the advertising parameters manager 60, can designate target Internet user 12 profiles and demographics. As discussed in detail below, profile information for each registered Internet user 12 is stored in the database 22. The Internet vendor 14 can, for example, target users 12 based on their geographic location, age, sex, religious or political affiliation, lifestyle preferences etc. The vendor 14 selects user profiles consistent with the value proposition of the vendor's 14 business and, thus, the targeted users 12 are likely to interact with the vendor's 14 website, content, messages or advertisements.

The advertising parameters manager 60 also enables Internet vendors 14 to view and change qualifying lead questions. Qualifying lead questions are questions designed to provide marketing information relative to the vendor's 14 defined market. For example, qualifying lead questions are designed to give the vendor data that is useful for developing more efficient and effective marketing strategies. For example, a health insurance provider may ask the following qualified lead questions of the Internet user 12: 1) do you currently have insurance; 2) do you have any preexisting conditions; and 3) are you interested in a group or individual policy?

The advertising parameters manager 60 also enables Internet vendors 14 to view and change Uniform Resource Locators (URLs) that link users 12 to its designated landing pages. Also, vendors 14 can input a list of its competitors URLs. Thus, when a user 12 lands on a competitor's website, the smart client 26 will present the vendor's 14 URL and advertisement to the user 12. The user 12 has incentive to click on the vendor's 14 hyperlink because, in exchange for the user's click, the vendor 14 will donate to the user's 12 designated beneficiary 16.

In an embodiment the community manager 62 (may also be referred to as an association manager 62 and/or affiliation manager 62) enables the vendor 14 to select communities with which the vendor 14 wishes to associate. Communities, for example, consist of Internet vendors 14, Internet users 12, and beneficiaries 16 that belong to and/or support or are otherwise affiliated with any common religious groups, charities, educational institutions, alumni groups, support groups, service organizations, civic groups, clubs, ethnic, political communities, political parties, unions, groups, associations, companies and the like. The communities may be non-profit, not-for-profit, or for-profit. Thus, for example, an Internet user's 12 search may be limited to those vendors 14 that associate with the Internet user's 12 designated communities. This community structure provides a granular way for Internet users 12, Internet vendors 14, and beneficiaries 16 to utilize the network 10 because it enables them to locate and support one another.

For example, the Internet vendor 14 is a small life insurance provider and, because of its limited size and available resources, it's internet marketing budget is a small amount relative to the larger life insurance providers. Thus, it's pledge and bid amounts are smaller in relation to larger life insurance providers. Further, the small life insurance provider, via the advertising parameters manager 60, designates “life insurance” as a search phrase and, via the community manager 62, designates “a local church” as a community with which it would like to associate. Because of its small budget and pledge amounts, the small life insurance provider may not appear on a search result list generated by the network 10 for an Internet user 12 searching the network 10 for “life insurance.”

The present invention addresses this concern by providing a sort and filter option by which the small life insurance provider would appear on the Internet user's 12 filtered search result list. For example, the small life insurance provider would appear on the search result list of an Internet user 12 that designates “the local church” as a community with which he or she would like to associate with and, further, the Internet user 12 utilizes a community search or filter methodology. The local insurance provider appears because both it and the Internet user 12 associate with “the local church.” It should also be appreciated that the small life insurance provider would appear on the search result list of an Internet user 12 that designates “the local church” as a beneficiary 16 to which he or she would like to support.

The community search methodology provides a granular way for the Internet user 12 to find an Internet vendor 14 that is associated with one of his or her communities, e.g., “the local church.” The community search or filter methodology is discussed in further detail below.

In an embodiment, the community manager 62 displays a list of all communities and the Internet users 12, Internet vendors 14, and beneficiaries 16 associated with the respective communities. Upon the Internet vendor's 14 request, the community manager 62 displays specific information about a particular community. For example, the vendor 14 can select a community, and the community manager 62 can display the community's mission statement, financial need, etc. The community manager 62 also contains a list of the most popular communities. The most popular communities, for example, are those communities comprising the largest number of Internet users 12, Internet vendors 14, and beneficiaries 16.

The vendor 14 can select communities by at least one of two ways. First, for example, the vendor 14 can manually select any number of registered communities. Second, for example, the vendor 14 can select ten registered communities and the community manager 62 will automatically associate with the most popular communities.

It should also be appreciated that within a particular community, a single entity can be an Internet user 12, an Internet vendor 14, and a beneficiary 16. For example, a community can comprise supporters of Campus Crusade, a Christian organization. Campus Crusade is an entity that consists of approximately one hundred ministries and ten thousand missionaries. Campus Crusade is supported, in part, by its donor base of approximately one million donors. The one million donors include, among others, Internet user's 12 and Internet vendor's 14, e.g., small businesses.

In one example, Campus Crusade is both an Internet user 12 and a beneficiary 16 when its agent accesses the network 10 to locate a product or service, e.g., a lawyer. In this example, it is in Campus Crusade's interest to locate a lawyer that is a member of the Campus Crusade community. Thus, Campus Crusade's agent accesses the network 10, as an Internet user 12, and searches for a lawyer. If the agent employees the community search or filter methodology, lawyers that associate with the Campus Crusade community will appear on the search result list. Thus, in this example, Campus Crusade is an Internet user 12 and a beneficiary 16. This is an example of the network 10 enabling a member to identify and utilize its constituency for its own benefit. It should also be appreciated that the lawyers in the Campus Crusade community can appear in the search result list in descending order based on their respective pledge and benefit amounts.

In another example, Campus Crusade is an Internet vendor 14. For example, Campus Crusade has an interest in spreading its Christian philosophy. To advance this interest, Campus Crusade can register in the network as an Internet vendor 14. Thus, providing incentive for Internet users 12 that are interested in generating support for their designated beneficiaries 16 to interact with Campus Crusade's website, content, messages or advertisements. This is an example of the network 10 fulfilling Campus Crusade's interested in spreading Christianity and concurrently providing incentive to Internet users 12 to access the Campus Crusade website by supporting the internet user's 12 designated beneficiaries 16.

The performance statistics manager 64 can be accessed by the vendor 14 to obtain information relative to the vendor's 14 website traffic resulting from the network 10. For example, the performance statistics manager 64 provides the number of user 12 searches returning the vendor's 14 advertisements, hyperlinks, content and/or messages. Also, the performance statistics manager 64 provides the number of “click thrus” to the vendor's 14 landing page, the number of submitted leads, the number of submitted qualified leads, and the number of user 12 calls made as a result of the vendor's 14 advertisements, hyperlinks, content and/or messages. It should be appreciated that the performance statistics manager 64 can be configured to provide other types of data compilations helpful to the vendor 14 in assessing its marketing success.

The billing manager 66 may be invoked from the vendor account manager 38. The billing manager 66 presents several choices to the vendor 14 for managing billing. For example, the vendor 14 can view a statement that details the amount the vendor 14 owes, in the form of pledges or bids to the system administrator 18, as well as any allocated benefits owed to each beneficiary 16. Also, the vendor 14 can make electronic payment directly to the beneficiaries 16 or the administrator 18. In one embodiment the vendor 14 pays the benefit amount directly to the beneficiary 16. In another embodiment, the administrator 18 pays the benefit amount to the beneficiary 16. The billing manager 66 also provides a statement of service fees owned to the administrator 18 and the option of making electronic payments to the administrator 18.

The vendor 14 account manager 38 also includes a policy and agreement presenter 68. Upon initiation by the vendor 14, the policy and agreement present 68 displays current network 10 policies and agreements applicable to the vendor's 14 use of the network 10. These policies and agreements are defined by the administrator 18 and are agreed to by the vendor 14 during registration.

Referring again to FIG. 4, an exemplary embodiment of the web application server 24 comprising the Internet user secure login 40 and the Internet user main page 42. For example in operation, the Internet user 12 accesses the web application server 24 via a web browser operating in the client computer 25, and the web application server 24 presents the Internet user secure login 40. Upon access to the Internet user secure login 40, the Internet user 12 inputs a valid username and password.

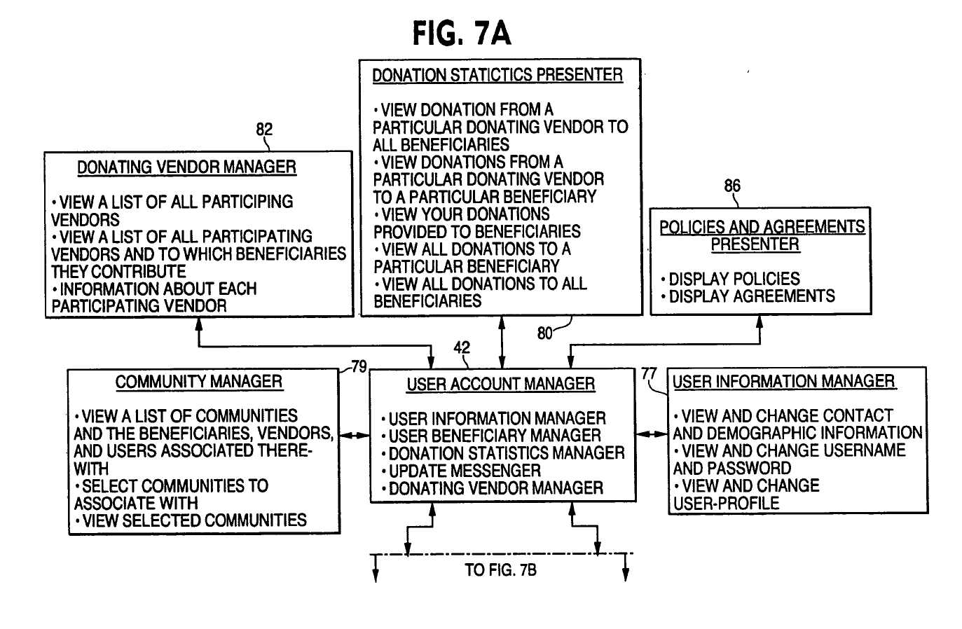

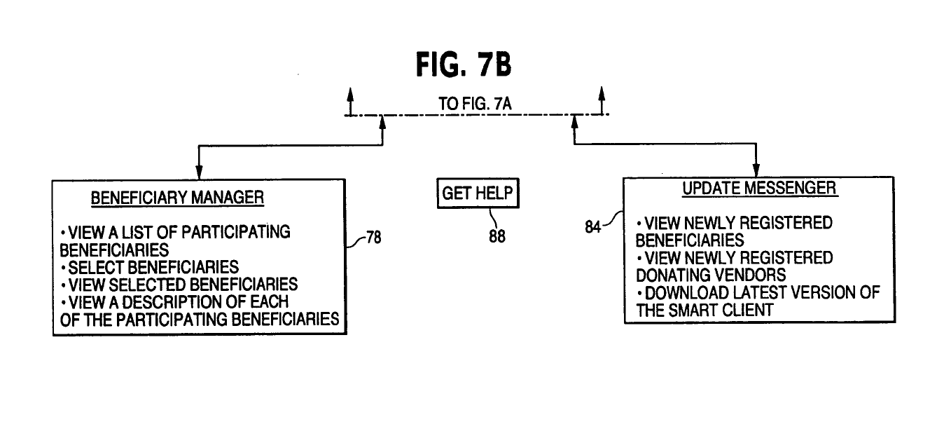

Referring now to FIG. 7, an exemplary embodiment of the Internet user account manager 42 is shown. Upon a successful login, the web application 24 provides the Internet user account manager 42. The Internet user account manager 42 has a number of options and further services for the Internet user 12. These items, which will be discussed in more detail below, cause routines to be invoked to either implement the Internet user's 12 request or request further information prior to implementing the Internet user's 12 request. In one embodiment of the present invention, the Internet user 12 may access several options through the Internet user account manager 42, such as the user information manager 77, the beneficiary manager 78, the community manager 79, the benefit statistics presenter 80, the Internet vendor manager 82, the update messenger 84, and policies and agreements viewer 86. A get help link 70 may also be available at the user account interface 42.

The user information manager 77 enables an Internet user 12 to, among other things, view and change his/her contact information and preferences. For example, the Internet user 12 can view and update his/her address, phone number, email address, and billing information. The Information manager 86 enables the Internet user 12 to configure the smart client to specific preferences such as a “local” definition as defined by proximity to the Internet user's zip code, activate and deactivate search engines where the smart client will execute parallel searches, activate and deactivate lead and qualifying messages, activate and deactivate the smart client's automated functions. The information manager 86 also allows the Internet user 12 to view and change his/her username and password. Further, the user 12 can view and change his/her profile information. For example, profile information includes the user's 12 age, sex, religious affiliation, location, etc.

The beneficiary manager 78 enables the user 12 to select beneficiaries 16 that best suit his/her preferences. The selected beneficiaries 16 will receive benefit amounts from an Internet vendor 14 upon the user's 12 interaction with the vendor's 14 website, content, advertisement or message. In one embodiment, the beneficiary 16 receives a benefit amount only when both the user 12 and the vendor 14 have designated that beneficiary 16. In another embodiment, the beneficiary 16 receives a benefit amount if one of the user 12 and the vendor has designated that beneficiary 16. In the preferred embodiment, the beneficiary 16 receives a benefit amount if the user 12 designates that beneficiary 16, and the Internet vendor 14 does not have an option of selecting beneficiaries 16. Instead, the Internet vendor 14 pledges to allocate benefit amounts to the user's 12 designated beneficiaries 16.

The beneficiary manager 78 displays a list of all registered beneficiaries 16. Upon the user's 12 request, the beneficiary manager 78 displays specific information about a particular beneficiary 16. For example, the user 12 can select a beneficiary 16, and the beneficiary manager 78 can display the beneficiary's 16 information such as but not limited to a mission statement, financial need, location, URL, etc. The beneficiary manager 78 also contains a list of the most popular beneficiaries 16. The most popular beneficiaries 16, for example, are those beneficiaries 16 selected by the largest number of Internet users 12.

The user 12 can manually select any number of register beneficiaries 16. It should be appreciated that the user 12 can select all beneficiaries 16. It should also be appreciated that instead of affirmatively selecting beneficiaries 16, the user 12 can negatively select beneficiaries 16. For example, the user 12 can select beneficiaries 16 for which he/she does not want to designate a benefit to. Thus, the user 12 can designate a benefit for all unselected registered beneficiaries 16.

In an embodiment, the community manager 79 enables the Internet user 12 to select communities with which he or she wishes to associate. Communities, for example, consist of Internet vendors 14, Internet users 12, and beneficiaries 16 that belong to and/or support common religious, educational, ethnic, political communities, etc.

In an embodiment, the community manager 79 displays a list of all communities and the Internet users 12, Internet vendors 14, and beneficiaries 16 associated therewith. Upon the Internet user's 12 request, the community manager 79 displays specific information about a particular community. For example, the Internet user 12 can select a community, and the community manager 79 can display the community's mission statement, financial need, etc. The community manager 79 also contains a list of the most popular communities. The most popular communities, for example, are those communities comprising the largest number of Internet users 12, Internet vendors 14, and beneficiaries 16.

The Internet user 12 can select communities by at least one of two ways. First, for example, the Internet user 12 can manually select any number of registered communities. Second, for example, the Internet user 12 can select ten registered communities and the community manager 79 will automatically associate with the most popular communities.

The performance statistics manager 80 can be accessed by the Internet user 12 to, among other things, obtain information relative to benefit amounts for which the user 12 was responsible for generating. For example, the performance statistics manager 80 provides the number of “click thrus” the user 12 has made to register vendors' 14 landing pages and the benefit amounts generated there from. Also, the performance statistics manager 80 provides the number leads and qualified leads the user 12 submitted to registered vendors' webpages. The performance statistics manager 80 can display the total benefit amount from a particular Internet vendor 14 and the applicable beneficiaries 16. The performance statistics manager 80 can also display the total benefit amount from all participating Internet vendors 14 to a particular beneficiary 16. It should be appreciated that the performance statistics manager 80 can be configured to provide other types of data to provide users 12 with detailed and helpful information

The user account manager 42 also includes a Internet vendor manager 82. The Internet vendor manager 82 provides a list of all registered vendors 14 and the corresponding beneficiaries 16 to which they are associated. The Internet vendor manager 82 also provides information to the Internet user 12 about each registered Internet vendor 14. Information provided by the Internet vendor manager 82 includes profile information, for example, whether the vendor 14 is a religious owned business, non-for-profit business, for-profit business, or a secular commercial business.

Further, the user account manager 42 includes an update messenger 84. The update messenger 84 provides the user 12 updates when new beneficiaries 16 registered with the network 10. The messenger 84 includes the newly added beneficiaries' 16 respective profile information. The update messenger 84 also provides the user 12 updates when new Internet vendors 14 registered with the network 10, and the messenger 84 provides profile information about each newly register Internet vendor 14. Further, the update messenger provides a hyperlink to download the latest version of the smart client 26.

The user 12 account manager 42 also includes a policy and agreement presenter 86. Upon initiation by the user 12, the policy and agreement present 86 displays current network 10 policies and agreements applicable to the user's 12 use of the network 10. These policies and agreements are defined by the administrator 18 and are agreed to by the user 12 during registration.

Referring again to FIG. 4, an exemplary embodiment of the web application server 24 comprising the beneficiary secure login 44 and the beneficiary main page 46. For example, in operation the beneficiary 16 accesses the web application server 24 via a web browser operating in the client computer 25, and the web application server 24 presents the beneficiary secure login 44. Upon access to the beneficiary secure login 44, the beneficiary 16 inputs a valid username and password.

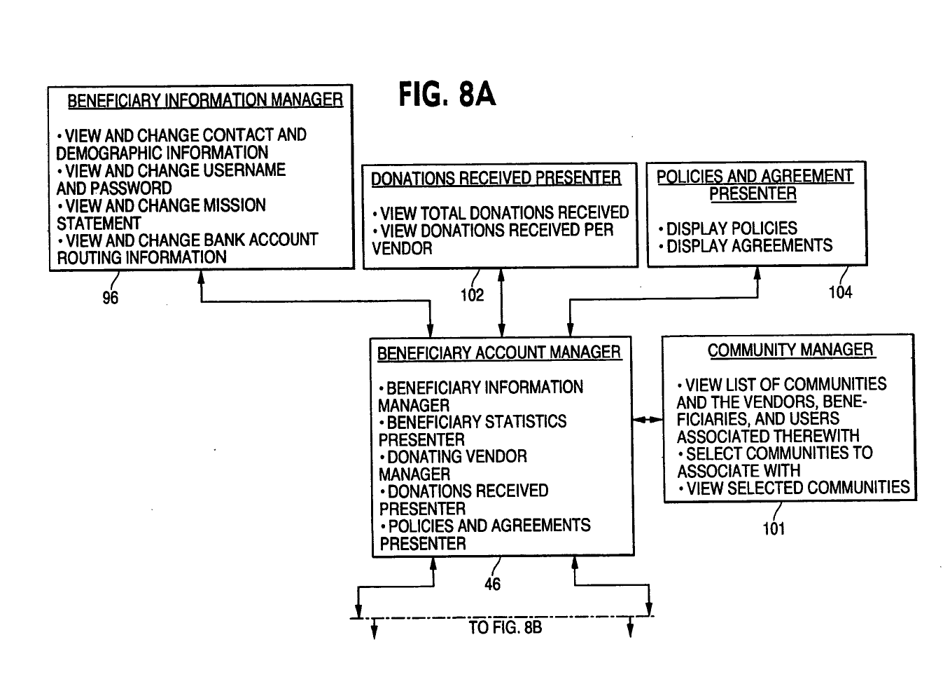

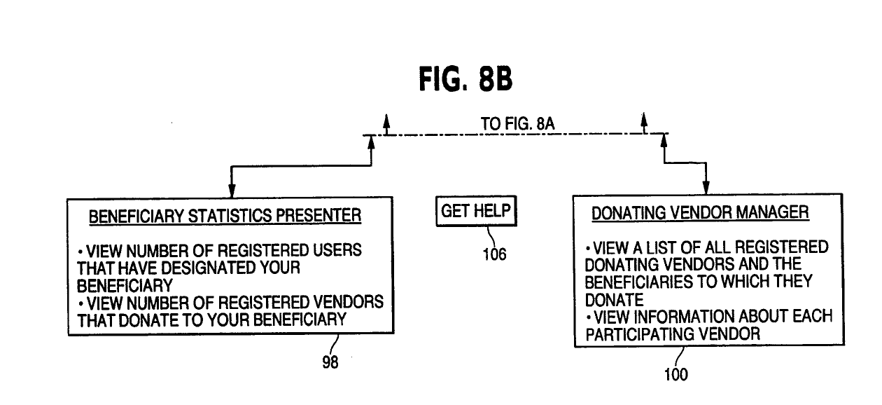

Referring now to FIG. 8, an exemplary embodiment of the beneficiary account manager 46 is shown. Upon a successful login, the web application server 24 provides the beneficiary account manager 46. The beneficiary account manager 46 has a number of options and further services for the beneficiary 16. These items, which will be discussed in more detail below, cause routines to be invoked to either implement the beneficiary's 16 request or request further information prior to implementing the beneficiary's 16 request. In one embodiment of the present invention, the beneficiary 16 may access several options through the beneficiary account manager 46, such as the beneficiary information manager 96, the beneficiary statistics presenter 98, the Internet vendor manager 100, the community manager 101, the donations received presenter 102, and policies and agreements presenter 104. A get help link 106 may also be available at the beneficiary account interface 46.

The beneficiary information manager 96 enables a beneficiary 16 to, among other things, view and change its contact and demographic information. For example, the beneficiary 16 can view and update its address, phone number, and email address. The beneficiary information manager 96 also enable the beneficiary 16 to view and change it bank account routing information. Further, the beneficiary information manager 96 allows the beneficiary to view and change its username and password. The beneficiary 16 can view and change its mission statement via the beneficiary information manager 96. For example, the mission statement provides Internet vendors 14 and Internet users 12 with information about services provided by the beneficiary 16. Further the mission statement indicates whether the beneficiary is a religious or secular organization.

The beneficiary 16 can access the statistics presenter 98 to, among other things, view the number of registered users 12 and vendors 14 that have designated the beneficiary 16. The beneficiary account manager 46 also includes an Internet vendor manager 100. The Internet vendor manager 100 provides a list of all registered vendors 14 and the corresponding beneficiaries 16 to which they allocate benefits. The Internet vendor manager 100 also provides information to the beneficiary 16 about each registered Internet vendor 14. Information provided by the Internet vendor manager 100 includes profile information, for example, whether the vendor 14 is a religious owned business, non-for-profit business, for-profit business, or a secular commercial business. Information obtained from the Internet vendor manager 100 enables beneficiaries 16 to efficiently and effectively solicit Internet vendor 14 and thereby encourage the Internet vendor 14 to allocate benefits to the beneficiary 16.

In an embodiment the community manager 101 enables the beneficiary 16 to select communities with which it wishes to associate. Communities, for example, consist of Internet vendors 14, Internet users 12, and beneficiaries 16 that belong to and/or support common religious, educational, ethnic, political communities, etc.

In an embodiment, the community manager 101 displays a list of all communities and the Internet users 12, Internet vendors 14, and beneficiaries 16 associated therewith. Upon the beneficiary's 16 request, the community manager 101 displays specific information about a particular community. For example, the beneficiary 16 can select a community, and the community manager 101 can display the community's mission statement, financial need, etc. The community manager 101 also contains a list of the most popular communities. The most popular communities, for example, are those communities comprising the largest number of Internet users 12, Internet vendors 14, and beneficiaries 16.

The beneficiary 16 can select communities by at least one of two ways. First, for example, the beneficiary 16 can manually select any number of registered communities. Second, for example, the beneficiary 16 can select ten registered communities and the community manager 101 will automatically associate with the most popular communities.

The beneficiary can access the benefits received presenter 102 to view a statement of the total benefits received and a statement of the total benefits received per vendor 14. The beneficiary account manager 46 also includes a policy and agreement presenter 104. Upon initiation by the beneficiary 16, the policy and agreement present 104 displays current network 10 policies and agreements applicable to the beneficiary's 16 use of the network 10. These policies and agreements are defined by the administrator 18 and are agreed to by the beneficiary 16 during registration.

Referring again to FIG. 4, an exemplary embodiment of the web application server 24 comprising the administrator secure login 48 and the administrator account manager 50. For example, in operation the administrator 18 accesses the web application server 24, and the web application server 24 presents the administrator secure login 48. Upon access to the administrator secure login 48, the administrator 18 inputs a valid username and password.

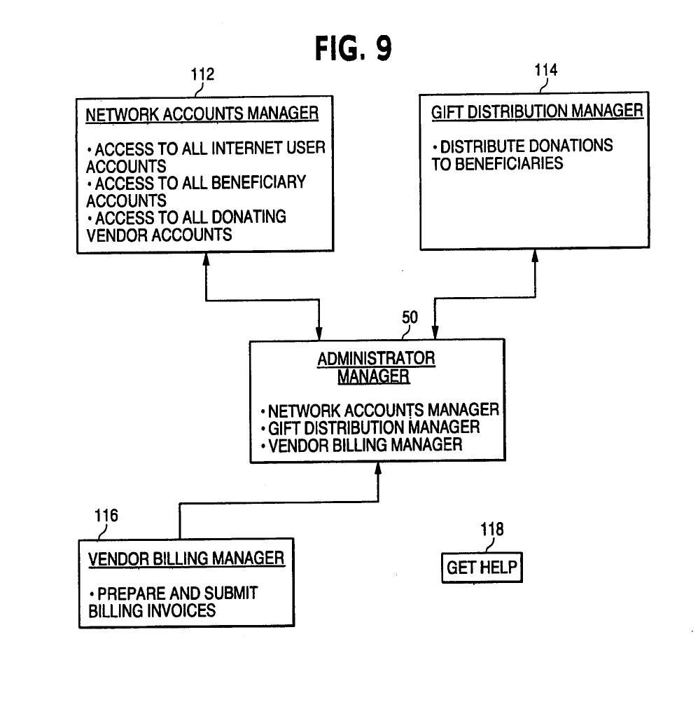

Referring now to FIG. 9, an exemplary embodiment of the administrator account manager 50 is shown. Upon a successful login, the web application server 24 provides the administrator account manager 50. The administrator account manager 50 has a number of options and further services for the administrator 18. These items, which will be discussed in more detail below, cause routines to be invoked to either implement the administrator's 18 request or request further information prior to implementing the administrator 18 request. In one embodiment of the present invention, the administrator 18 may access several options through the administrator account manager 50, such as the network accounts manager 112, gift distribution manager 114, and the vendor billing manager 116. A get help link 118 may also be available at the administrator account interface 50.

The network accounts manager 112 enables the administrator 18 to access and utilize the respective account managers of all registered Internet users 12, Internet vendors 14, and beneficiaries 16. The administrator 18 has access to all of the tools provided by the respective account managers. This access enables the administrator 18 to monitor network 10 activity from the prospective of all participants.

The network accounts manager 112 enables the administrator 18 to view and edit, among other things, posted mission statements, listed URLs, need statements, advertisements, etc. If a network 10 participant is not in compliance with network 10 policies, the administrator 18, by-way-of the network accounts manager 112, can deactivate the non-compliant account. Further, the network accounts manager 112 enables the administrator 18 to review and authorize each account upon registration of a new Internet user 12, Internet vendor 14, or beneficiary 16.

The benefit distribution manager 114 distributes benefits to beneficiaries 16. For example, the benefits distribution manager 114 can either prepare a check or electronically route donations to beneficiaries 16. The billing manager 116 prepares billing invoices and credit card charges for submission to Internet vendors 14.

Referring now to FIGS. 10 and 11, embodiments of the smart client in accordance with the invention main page 140 are shown. Upon activation of the smart client 26, the smart client main page 140 is presented to the Internet user 12. The smart client main page 140 provides the option of browsing the network 10 via a search tool 142, a favorites tool 144, a purchases tool 146, and a discounts tool 148.

The search tool 142 facilitates the Internet user's 12 remote access to the web server 28 and executes a search request according to the procedure described previously. The web server 28 preferably generates and displays, via the smart client 26, a search result list in the ad display window 154. The previous search tool 143 stores resent searches conducted by the smart client 26. The Internet user 12 can access the previous search tool 143, select a previous search, and rerun the search.

The favorites tool 144 enables the Internet user 12 to save a search. This feature is distinct from the previous search tool 143 at least because the search results can be saved, grouped and assigned a name. The discounts tool 148 enables Internet user 12 to sort and filter search results of products and services for which they are currently interested in buying by those Internet vendors 14 who are offering specific discounts and promotions to Internet users 12. The discounts tool presents the discount information to the Internet users 12 by accessing discount Internet vendor account manager 38. The purchases tool 146 enables the Internet user 12 to broadcast and designate the intent to purchase specific products and services in the near future. This information is provided to Internet vendors 14 and based on the information, the vendors 14 can directly advertise to the Internet user 12 through custom offers and promotions

Also provided to the Internet user 12 is a preferences tool 150. The my preferences tool 150 links the Internet user 12 to the Internet user account manager 42 where the user 12 can change his/her account settings and preferences. It should also be appreciated that the preferences tool 150 provides the internet user 12 with a menu of configuration and personal preference options applicable to the smart client 26. Further, a help tool 152 is provided, which present a context specific help menu or connects the user to help webpage maintained by the administrator 18.

An Internet user 12 may invoke the smart client 26 to employ a benefit amount methodology to filter and sort certain search results by indicating the benefit amount tool 172. It should be appreciated that the benefit amount tool may carry a label that is most relevant to user group (e.g. Pledges, Cash, Rewards) For example, as shown in FIG. 11, a search for “life insurance” may generate a list of advertisements from life insurance providers 14 in descending order from the highest benefit amount to the Internet user 12. A smart client 26, that has been customized and labeled to be relevant to a large community of Christians who are interested in directing benefits to churches generates this list by invoking the benefit amount tool that has been labeled “pledges”. Invoking the “Pledges” benefit tool references the pledge or bid amount information in the Internet vendor account manager 38.

Localization methodologies may also be employed to filter and sort certain searches by indicating the local tool 174. For example, a search for “life insurance” may be limited to those insurance providers 14 within a selected city, zip code, or telephone area code. It should also be appreciated that a search for “life insurance” may generate a list of life insurance providers 14 in descending order from the provider 14 closest to the Internet user 12. It should also be appreciated that a search for “life insurance” may generate a list of providers within defined proximity of the Internet user's zip code and those providers are listed in descending order based on the benefit amount. The smart client 26 generates this list by cross-referencing information in the Internet user account manager 42 and information in the Internet vendor account manager 38.

Also, a community methodology may be employed to sort and filter searches by indicating the community tool 174. For example, a search for “life insurance” may be limited to those vendors 14 within a selected religious, educational, ethnic, or political community. It should also be appreciated that a search for “life insurance” may generate a list of life insurance providers 14 in descending order from the provider 14 that shares at least one community with the Internet user 12. It should also be appreciated that a search for “life insurance” may generate a list of life insurance providers 14 in descending order from the provider 14 that donates to at least one community in which the Internet user 12 is a member. The smart client 26 generates this list by cross-referencing information in the Internet user account manager 42 and information in the Internet vendor account manager 38.

Moreover, an overall or qualitative ranking methodology may be employed to sort and filter searches by indicating the stars tool 178. For example, the smart client 26 simultaneously applies the benefit amount methodology, the localization methodology, and the community methodology. Upon application of the benefit amount methodology, the localization methodology, and the community methodology, the smart client 26, in the preferred embodiment, ranks the vendors 14 in descending order from the vendor 14 having the highest average rank among all of the tests. Thus, a search for “life insurance” may generate a list of life insurance providers 14 in descending order from the provider 14 having the highest average rank among all of the tests. It should be appreciated that the smart client 26 can assign at least a star thumbnail 180 to each vendor's 14 hyperlink 182, and the number of star thumbnails 180 is directly proportional to the vendor's 14 average rank in the benefit amount methodology test, the localization methodology test, and the community methodology test. The smart client 26 generates this list and assigns the star thumbnails 180 by cross-referencing information in the Internet user account manager 42 and information in the Internet vendor account manager 38.

In an embodiment, the smart client 26 includes an auto-activation tool that either launches the smart client main page 140 or causes the browser toolbar button 186 to blink or change colors. If the user 12 clicks on the browser toolbar button 186, the smart client main page 140 will launch. For example, the auto-activation tool activates the main page 140 when the smart client 26, based on the Internet user's 14 activity, finds a match when it cross-references information in the Internet user account manager 42 and information in the Internet vendor account manager 38. An example of the auto-activation tool is used by Buypacts, Inc. in their toolbar application, which can be downloaded at www.buypacts.com.

In an embodiment, the smart client 26 can initiate a search in response to at least one of at least four stimuli. First, the smart client main page 140 can be activated by a contextual search activation. The smart client 26 automatically detects that a search activity is being employed at a search engine (e.g., GOOGLE, MSN, YAHOO, etc) or on a website having its own search engine and determines the search terms. Based on the detected search terms, the smart client 26 conducts its own search of the web server 28. It should be appreciated that the auto-activation method is a parallel search with Internet user's search at traditional search engine or website with search capabilities. It should also be appreciated that the parallel search in no way suppresses or restricts the results offered by the traditional search engine or website. Second, the smart client 26 cross-references the URLs on which the Internet user 12 lands with designated URLs listed in the advertising parameters manager 60 of the vendor account manager 38. When an Internet user 12 lands on a designated URL, the smart client 26 presents the Internet vendor's 14 advertisement or content to the Internet user 12. Third, the smart client 26 contextually scans the content of the web page being viewed by the Internet user 12 for keywords and search terms listed in the advertising parameters manager 60 of the vendor account manager 38. When an Internet user 12 lands on a web page containing designated keywords and search terms, the smart client 26 presents the Internet vendor's 14 advertisement to the Internet user 12. Fourth, the Internet user 12 manually inputs keywords and search terms into the search tool 142 and clicks on the go tool 145.

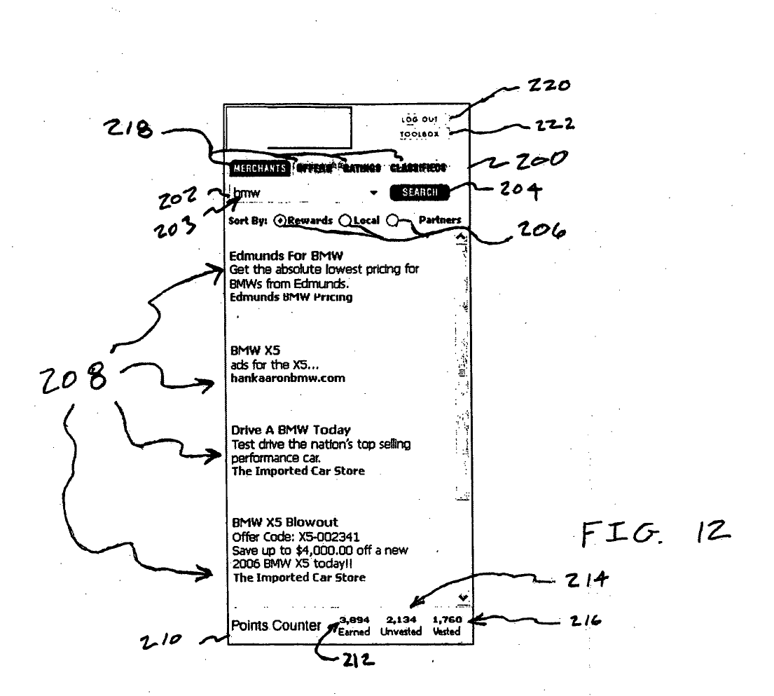

FIG. 12 shows a display window 200 associated with a permissive search method in accordance with another embodiment of the invention. In some embodiments of the invention, the term permissive search agent (PSA) is used to describe a system a user permits to monitor the user's search behavior as described above and below. The system is not limited to the internet, but can be used on wireless, cable, satellite, or cellular networks. In fact, the system can be used in accordance with the invention on any device that connects with a network.

A user can input a user profile into a PSA and the PSA will return search results according to the data the user input into the PSA and vendors associated with the PSA that offer rewards to the user or user's beneficiaries.

For example, the user can input into the PSA profile data, such as (but not limited to) a desired geographical location for vendors, types of awards or benefits vendors grant, communities that vendors associate with, or any other type of affiliation that a vendor may have that the PSA returns in search results.

Of course, vendors have entered vendor profile data including (but not limited to) geographical location for the vendors, types of awards or benefits vendors grant, communities that vendors associate with, or any other type of affiliation that a vendor may have. This data is stored by the PSA so that the PSA can use the data to match vendors to users when a user conducts a search.

The display window 200 (sometimes referred to herein as a PSA window 200) can be displayed by it self on a users electronic device, such as a mobile phone, personal digital assistant (PDA), TV, computer screen, or any other device suitable device that a user may access the PSA. The PSA can work with any search engine. The display window 200 can appear on a search engine screen as shown in FIG. 11. In some embodiments, it may over lay the search engine screen or in other embodiments it may not cover any of the search engine screen but make the search engine screen smaller to make room to display the display window 200 as shown in FIG. 11.

The display window 200 includes a search window 202. In the search window 202 a user may enter a search term 203 the user wishes to search to obtain search results. In some embodiments of the invention, the search term 203 is entered in the search engine as shown in FIG. 11 where the term “Life Insurance” has been entered by way of example. Because the PSA monitors the users searches, the search term 203 is automatically entered in the search window 202 (See the term “Life Insurance” entered in the search window 202 of FIG. 11). By initiating the search in the search engine, search results are returned both by the search engine and the PSA as shown in FIG. 11.

The PSA window 200 includes a search button 204 that can be clicked in order to initiate a search by the PSA. In some embodiments clicking the search button 204 will also initiate a search by the search engine.

Sorting buttons 206 allow a user to sort the search results returned by the PSA. For example, the sorting buttons 206 shown in FIG. 12 permit sorting of the search results by an amount of awards offered by a vender, venders located in a local (to the user) area, and venders identified as partners. In other embodiments, sorting can be done by community, discounts and offers, redemption sites (sites where reward point can be redeemed), user ratings, and popularity. Other sorting factors can also we used in accordance with the invention.

Under the sorting buttons 206 the search results are displayed the returned search results that includes some of the vendor information 208. For example the displayed vendor information 208 can include the vendor name, a web address, inducements or promotional material such as special sales or offers. The vendor information that can be displayed can include a plug-in, a message toast, or suitable way to display information that references information in the vendors account. Other vendor data can be accessed by a user clicking on a portion of the displayed vendor information 208 that comprises a link to additional information. The vender information that is presented to a user can be in the form of an advertisement and questions from the vendor to the user.

Below the vendor information, a points counter box 210 is located. The points counter box 210 indicates how many points 212 (a benefit) that the user has accrued. Often the points 212 accrue by a user accessing data and/or purchasing items from a vendor. The user can obtain benefits (points) for interacting with a vendor's website, advertisement, content, or message that is promoted/generated by the vendor. The vendor pledges or bids a specific monitory amount to the system operators for various activities a user does with vendor (or vendor sponsored) data.

For example, if a user clicks on a link turned up in the search results contained in the window 200 that action generates an amount to the system operators from the vendor whose link was clicked on. Likewise, if a user directed to a vendor via the PSA answers questions from a vendor, the vendor bid or pledged amount previously arranged by the vendor and the system operators is due the system operators for that activity. Of course, other user activities can generate amounts due the system operators by the vendor. A portion of the amount due (sometimes called the pledge or bid amount) is given to the user in the form of points or some other benefit. The amount the user gets for interacting with a vender via the PSA can be between 0% and 100% of the amount due the system operators from the vendor for that user activity. The exact percentage or amount is set by either the vendor or the vendor and system operators.

In some embodiments of the invention, the user's benefits are tracked in the form of points 212. The points 212 can be redeemable for cash, at a selected conversion rate, or credit from a vendor to be applied toward purchases from the vendor. The points 212 can also be in the form of airline miles, or some other non-monetary benefit. The points 212 can be used or redeemed by a user, or a beneficiary identified by a user. For example the beneficiary may be a trust, a charity, a political or religious organization, an IRA, an HSA, a 529 plan, stock shares, a mutual fund, a bank account, school or any other entity or account. The user may have several accounts indicating how many points 212 are in each account. Further, each account may have a different beneficiary. The points counter box 210 may indicate how may points 212 are in each account. Optionally, different accounts may be selected to display the earned points 212 any given time.

The points 212 can be vested or unvested. The unvested points 214 and the vested points 216 may be displayed in the points counter box 210. The vested points 214 are available for immediate use by the user. The vested points 216 may need some further act in order to be redeemable by the user. Acts necessary to vest the points can include entering a promotion code, redeeming a coupon with the vendor, making purchases, answering survey questions, the passage of time or any other suitable act to cause the points to vest.

In the exemplary PSA window illustrated in FIG. 12, search category tabs 218 present. A user can set one of these tabs 218 to be a default tab or the active tab may be the one last selected. In FIG. 12, tab titled “Merchants” is the active tab. The tabs 218 are configured so that the active tab will cause that a search will yield search results according to the active tab.

For example, because the merchants tab is active in FIG. 12, any searches done by the PSA system will yield vendors that have indicated in their vendor profiles that they are merchants as results. If the “offers” tab 218 is active, the search results will yield vendors that have indicated in their vendor profiles a special offer and display what the special offer is. Normally special offers are available for a limited time. The special offers can include (but are not limited to) an extra amount of points for actions done by a user or special discounts on items or services sold by the vendor.

If the ratings tab is active, the search results will be sorted by vendors having the highest rating (customer satisfaction) as judged by users of the PSA system. Some embodiments of the invention permit users of the system to rate vendors similar to well know rating systems of on-line vendors.

If the classified tab is active, the search results will access an electronic database of classified adds and return classified adds as results of the search.

The log out button 220 is located at the top left of the PSA window 200 in FIG. 12. However, embodiments of the invention that use a log out button 220, can have the button 220 located in any suitable location. To log out of the system, a user can click on the log out button 220. Clicking on the log out button 220 can log the user out of the system and close the PSA window. When the user has logged out, the system will stop monitoring the user's activity.

The PSA window 200 shown in FIG. 12 includes a tool box 222 button. The tool box button 222 when clicked on permits the user to perform maintenance to the users account. For example, the user can add to, delete or other wise modify the user's preference and profiles. For example, the profile can include the user's password. The user can change the password through the toolbox 222 as desired. Other items a user can modify via the toolbox 222 include the user's preferred payment solutions such what method of payment the user prefers, beneficiaries of points accrued by a user. Other suitable user data can also be modified via the tool box 222 in accordance with the invention.

User preferences are also accessed and modified via the tool box 222. Examples of preferences a user can modify include a preferred geographic area for venders to be located, preferred communities for venders to be affiliated with, white lists and black lists of preferred vendors and non preferred vendors and preferred third parties venders will provide benefits (i.e. points).

In some embodiments of the invention, the PSA may be equipped with a tiered system of preferences to enable a parent to modify a child's preferences and profile while allowing the child to modify their own profile in only a limited way. In this manner a parent is enabled to limit what types of search results can be returned. Also, the PSA can notify a parent if various blacklisted search terms have been attempted to be searched. Similar systems can be used for employers monitoring employee searches and schools monitoring student searches. Other suitable preferences and also be modified via the toolbox 222.

The preferences and profiled are used during the PSA search routines to determine the outcome of the search results returned by the PSA. In some embodiments of the invention, the tool box button 222 can be used to access other accounts the user may have and access such things as conversion calculators to determine how convert points in to other benefits.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for enabling an Internet user to appropriate a benefit by interacting with a website, content, advertisement or message that is promoted by an Internet vendor, comprising:
an Internet vendor account for each of a plurality of Internet vendors registered in the system, wherein the Internet vendor account includes a pledge or bid amount;
an Internet user account for each of a plurality of Internet users registered in the system; and
a smart client configured to monitor a user activity of the Internet user, present data of the Internet vendor account, invoke the sorting and filter of data of the Internet vendor account, invoke the cross-referencing of data of the Internet users account with data of the Internet vendor's account, monitor a user activity of the Internet user with the Internet vendor's data or content, and provide the user activity to a web server,
wherein the web server is configured to return requests made by the smart client and allocate the benefit based on the user activity.

2. The system of claim 1, further comprising a beneficiary account for each of a plurality of beneficiaries registered in the system.

3. The system of claim 1, wherein the benefit is appropriated to the Internet user.

4. The system of claim 1, wherein the benefit is appropriated to a beneficiary.

5. The system of claim 1, wherein the benefit is a portion of a pledge or bid amount and the portion is calculated by a conversion rate applied to the pledge or bid amount.

6. The system of claim 1, wherein the benefit is a direct or indirect monetary incentive that is allocated in the form of cash, deposits into an account owned by the Internet user's, vested reward points, unvested reward points, or donations to third parties.

7. The system of claim 1, wherein the Internet user account includes a beneficiary to which the Internet user wishes to appropriate the benefit.

8. The system of claim 7, wherein the benefit is appropriated to the beneficiary upon interaction of the Internet user with the website, content or ad promoted by the Internet vendor.

9. The system of claim 1, wherein the pledge or bid amount is a landing page hit amount, and a portion of the landing page hit amount is the benefit appropriated when the Internet user clicks on a hyperlink, message, ad or image of the Internet vendor.

10. The system of claim 1, wherein the pledge or bid amount is a lead amount, and a portion of the lead amount is the benefit allocated when the Internet user submits data of the Internet user account to the Internet vendor.

11. The system of claim 1, wherein the pledge or bid amount is a qualified lead amount, and a portion of the qualified lead amount is the benefit appropriated when the Internet user provides the Internet vendor with an answer to each of a plurality of qualifying lead questions.

12. The system of claim 1, wherein the pledge or bid amount is a call amount, and a portion of the call amount is the benefit appropriated when the user activity results in the Internet user calling the Internet vendor.

13. The system of claim 1, wherein the web server is configured to cross-reference the user activity or data input with data of the Internet vendor account to identify a common term or data input, and the smart client is configured to present data of the Internet vendor account to the Internet user when the web server identifies the common term or data input.

14. The system of claim 13, wherein the smart client is automatically activated when the web server identifies the common term or data input.

15. The system of claim 14, wherein the smart client automatically activates by launching a browser plug-in and populates the browser plug-in with content and data of the Internet vendor.

16. The system of claim 15, wherein the smart client automatically activates by providing a highlighted browser toolbar buttons, and the Internet user can click on a highlighted browser toolbar button to launch the browser plug-in.

17. The system of claim 15, wherein the smart client automatically activates by providing a message or image icon to the Internet user, wherein the message or icon informs the Internet user of a Internet vendor offer or content.

18. The system of claim 1, wherein the smart client includes a ratings tool configured to sort the plurality of Internet vendors by a ratings value, and the rating value is based on a number of occasions the website of the Internet vendor is accessed by the plurality of Internet users or the sum of the ratings assessed by the plurality of Internet users, or average of the ratings assessed by the plurality of Internet users.

19. The system of claim 18, wherein the smart client includes a benefit amount tool configured to sort the plurality of Internet vendors by a benefit amount value, and the benefit amount value is based on the pledge or bid amount of each of the respective Internet vendors.

20. The system of claim 19, wherein the smart client includes a local tool configured to sort the plurality of Internet vendors by a proximity value, and the proximity value is based on a physical distance between a location of the Internet vendor and a user location of the Internet user.

21. The system of claim 20, wherein the smart client includes a star ranking tool configured to sort the plurality of donating vendors by a star ranking value, and the star ranking value is based on the popularity or rating value, the benefit amount, and the proximity value.

22. The system of claim 1, wherein the smart client includes a drop-down list configured to display a plurality of recent search results.

23. The system of claim 1, wherein the smart client includes a keyword search tool configured to display a plurality of recent search results.

24. The system of claim 1, wherein the smart client includes a favorites tool configured to display a plurality of saved search results.

25. The system of claim 1, wherein the smart client includes a discounts or offers tools configured to display a plurality of discounts offered to the Internet user by the Internet vendors.

26. The system of claim 25, wherein the discounts displayed by invoking the discount or offers tool include a discount or offer code provided by the Internet vendor.

27. The system of claim 1, wherein the smart client includes a purchase agent tool configured to display a plurality of target Internet vendors who can supply a potential purchase, and the potential purchase is designated by the Internet user.

28. The system of claim 1, wherein the smart client includes a preferences tool, wherein the preferences tool launches the Internet user login device and gives the Internet user access to the Internet user's account information and preferences.

29. A method for enabling an Internet user to appropriate a benefit by interacting with a website, content, advertisement or message that is promoted by an Internet vendor, comprising:
maintaining a database having stored thereon:
an Internet vendor account for each of a plurality of Internet vendors registered in the system, wherein the Internet vendor account includes a pledge or bid amount;
a benefit amount that has been calculated from a conversion rate of the pledge or bid amount
an Internet user account for each of a plurality of Internet users registered in the system;
monitoring a user activity of the Internet user;
cross-referencing the user activity or data input with data input of the Internet vendor account to identify a common term or data input;
presenting data of the Internet vendor account when the common term or data input is identified;
sorting and filtering the Internet vendor data based on the tools invoked by the Internet user
monitoring an interaction between the Internet user and the website, content, advertisement or message that is promoted by the Internet vendor; and
allocating the benefit.

30. The method of claim 29, wherein the benefit is allocated to the Internet user.

31. The method of claim 29, wherein the benefit is allocated to a beneficiary.

32. The method of claim 29, wherein the database further comprising a beneficiary account for each of a plurality of beneficiaries registered in the system.

33. The method of claim 29, wherein the pledge or bid amount is a landing page hit amount, and a portion of the landing page hit amount is the benefit allocated when the Internet user clicks on hyperlink test, image or message of the Internet vendor.

34. The method of claim 29, wherein the pledge or bid amount is a lead amount, and a portion of the lead amount is the benefit allocated when the Internet user submits data of the Internet user account to the Internet vendor.

35. The method of claim 29, wherein the pledge or bid amount is a qualified lead amount, and a portion of the qualified lead amount is the benefit allocated when the Internet user provides the Internet vendor with an answer to each of a plurality of qualifying lead questions.

36. A method for providing an incentive to an Internet user to interact with a website, content or ad, comprising:
monitoring a user activity of an Internet user;
searching a database for an Internet vendor based on the user activity;
presenting a hyperlink, text, advertisement, content, message or image icon that is maintained by the Internet vendor;
monitoring an interaction between the Internet user and the website, text, advertisement, content, message or image icon; and
allocating a benefit based on the Internet user's collective interactions with the website, text, advertisement content, message or image icon.

37. The method of claim 36, wherein the benefit is allocated to the Internet user.

38. The method of claim 36, wherein the benefit is allocated to a beneficiary.

39. The method of claim 38, wherein the beneficiary is a charity or third party

40. The method of claim 36, wherein the beneficiary is selected by the Internet user.

41. The method of claim 36, further comprising the step of submitting a Internet user data to the Internet vendor upon the interaction.

42. The method of claim 36, further comprising the step of prompting the Internet user to submit a first marketing data to the Internet vendor.

43. The method of claim 38, further comprising the step of allocating a second benefit.

44. The method of claim 43, further comprising the step of prompting the Internet user to submit a second marketing data to the Internet vendor.

45. The method of claim 44, further comprising the step of allocating a third benefit.

46. The system of claim 1, wherein the system is configured to permit the user to selectively have the smart client monitor the users activity.

47. The method of claim 29, further comprising permitting the user to select to have or not have the user's activity be monitored.

48. The method of claim 36, further comprising permitting the user to select to have or not have the user's activity be monitored.
